(19) United States
(12) Patent Application Publication
(10) Pub. No.: US 2015/0228944 A1
(43) Pub. Date: Aug. 13, 2015

(54) FIXING TUBE AND ELECTRONIC APPARATUS

(71) Applicant: HTC CORPORATION, (US)

(72) Inventors: Shu-Feng Lin, Taoyuan County (TW); Yung-Ling Chou, Taoyuan County (TW); Chih-Kai Hu, Taoyuan County (TW)

(73) Assignee: HTC CORPORATION, Taoyuan County (TW)

(21) Appl. No.: 13/681,428

(22) Filed: Nov. 20, 2012

Related U.S. Application Data
(60) Provisional application No. 61/645,073, filed on May 10, 2012.

(51) Int. Cl. H01M 2/10

(52) U.S. Cl. CPC H01M 2/1066

(57) ABSTRACT

A fixing tube suitable for accommodating a battery and fixing the battery in a body of an electronic apparatus. The fixing tube includes a tube body. The tube body has an accommodating space, and the tube body is made of a breakable material. The battery is suitable for being accommodated in the accommodating space, and the tube body is suitable for being adhered to the body, so as to fix the battery in the body. An electronic apparatus including the fixing tube is also provided.

### CROSS-REFERENCE TO RELATED DISCLOSURE

This application claims the priority benefits of U.S. provisional application Ser. No. 61/645,073, filed on May 10, 2012. The entirety of the above-mentioned patent applications is hereby incorporated by reference herein and made a part of this specification.

### BACKGROUND OF THE DISCLOSURE

1. Field of the Disclosure

The disclosure relates to an electronic apparatus. More particularly, the disclosure relates to an electronic apparatus having an embedded battery.

2. Description of Related Art

In current information era, human beings by degrees tend to rely on consumer electronics devices. The electronic products such as mobile phones, smart phones and tablet PC have pervaded everywhere. Therefore, consumer electronics devices and people nowadays are closely bonded together in daily life. Electronic devices nowadays are generally included with a battery configured to provide power required for system operations, so as to allow users to carry and use the devices anywhere.

Generally, the battery of the electronic device is disposed within its body, and no plastic protective shell is covered on a core of the battery so as to reduce overall thickness of the electronic device. However, the battery must be removed to proceed with maintenance for the electronic device. The battery without being protected by plastic protective shell may easily be deformed under force applied during the process of detaching the battery, so as to further increases maintaining costs.

### SUMMARY OF THE DISCLOSURE

The disclosure is directed to a fixing tube capable of fixing a battery to a body, and preventing the battery from deformation caused by external forces during the process of detaching the battery from the body.

The disclosure provides an electronic apparatus, in which a battery may be fixed to the a body through a fixing tube and the battery from deformation caused by external forces during the process of detaching the battery from the body may be prevented.

The disclosure provides a method for detaching a battery, the method may be used to prevent the battery from deformation caused by external forces during the process of detaching the battery.

The disclosure provides a fixing tube suitable for accommodating a battery and fixing the battery in a body of an electronic apparatus. The fixing tube includes a tube body. The tube body has an accommodating space and the tube body is made of a breakable material. The battery is suitable for being accommodated in the accommodating space, and the tube body is suitable for being adhered to the body, so as to fix the battery in the body.

The disclosure provides an electronic apparatus, including a body, a battery and a fixing tube. The battery is disposed within the body. The fixing tube is disposed between the body and the battery, the fixing tube includes a tube body. The tube body has an accommodating space and the tube body is made of a breakable material. The battery is suitable for being accommodated in the accommodating space, and the tube body is suitable for being adhered to the body, so as to fix the battery in the body.

The disclosure provides a method for detaching and attaching battery, suitable for detaching the battery from a body of the electronic apparatus. The fixing tube includes a tube body, and the tube body includes an accommodating space. The battery is accommodated in the accommodating space, and the tube body is adhered to the body, so as to fix the battery in the body. The method for detaching the battery includes destroying the tube of the fixing tube so that tube body cannot fix the battery to a position corresponding to the body, and removing the battery from the body.

In view of above, the battery of the electronic apparatus of the disclosure, the batter thereof is capable of being fixed together with the body through the fixing tube. The fixing tube has an accommodating space for accommodating the battery, and a tube body of the fixing tube is composed by a breakable material. Once the battery is to be removed from the electronic apparatus, only the fixing tube is required to be torn, so that the tube body may be destroyed to fix the battery in the body correspondingly, such that battery may be removed from the body. During the process of detaching the battery from the body of the electronic apparatus, despite that the fixing sheet is destroyed, the battery may substantially remain its original appearance. As a result, not only that the battery may be prevented from damages, maintaining costs of the electronic apparatus may also be reduced.

To make the above features and advantages of the disclosure more comprehensible, several embodiments accompanied with drawings are described in detail as follows.

### BRIEF DESCRIPTION OF THE DRAWINGS

FIG. 1A is a schematic view of a fixing tube according to an embodiment of the disclosure.

FIG. 1B is a schematic view illustrating the fixing tube of FIG. 1A from another view angle.

FIG. 1C is a schematic view illustrating assembly of the fixing tube and the battery of FIG. 1A.

FIG. 2 is a schematic view of an electronic apparatus utilizing the fixing tube and the battery of FIG. 1B.

FIG. 3 is a top view illustrating the fixing tube of FIG. 1A being unfold.

FIG. 4 is a flowchart illustrating a method for detaching and attaching the battery of the electronic apparatus of FIG. 2.

FIGS. 5A and 5B are schematic views respectively illustrating the electronic apparatus of FIG. 2 before the battery is detached and after the battery is detached.

### DESCRIPTION OF THE EMBODIMENTS

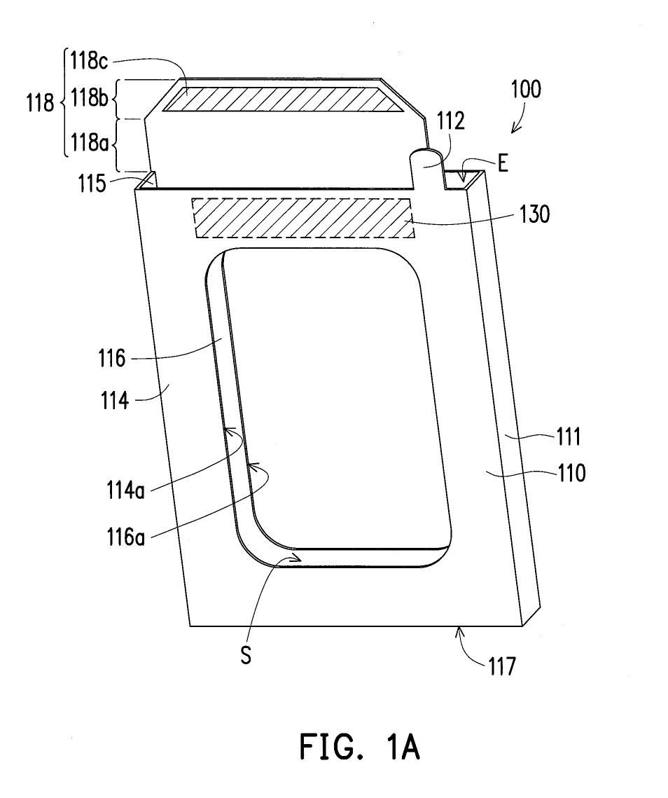

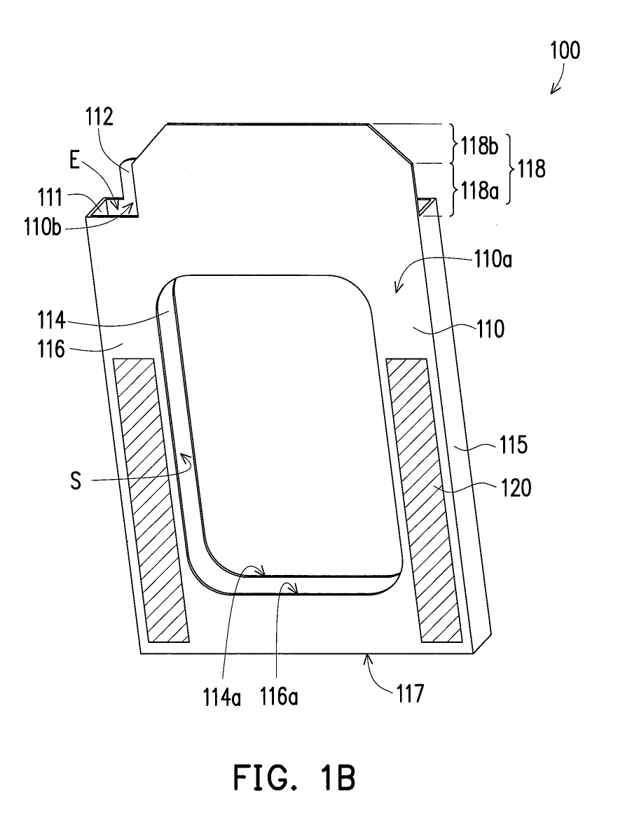

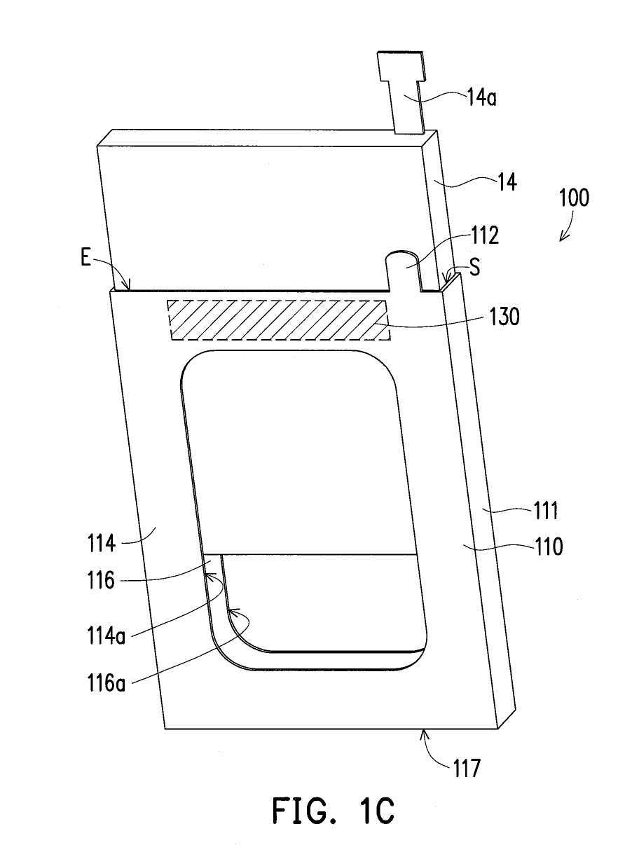

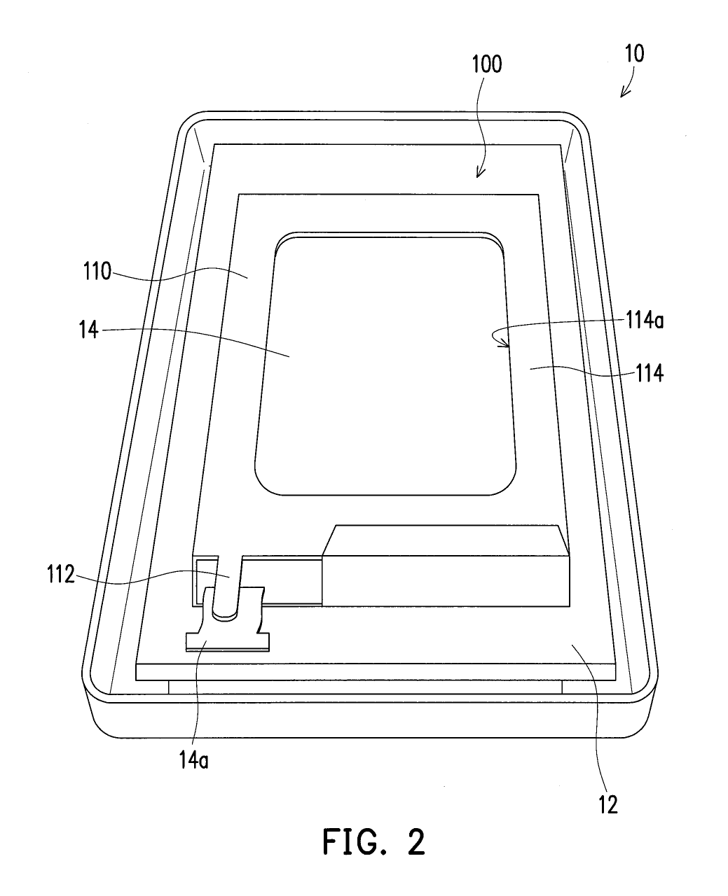

FIG. 1A is a schematic view of a fixing tube according to an embodiment of the disclosure. FIG. 1B is a schematic view illustrating the fixing tube of FIG. 1A from another view angle. FIG. 1C is a schematic view illustrating an assembly of the fixing tube and the battery of FIG. 1A. FIG. 2 is a schematic view of an electronic apparatus utilizing the fixing tube and the battery of FIG. 1B. Referring to FIG. 1A, FIG. 1C and FIG. 2 together, an electronic apparatus 10 of the present embodiment includes a body 12, a battery 14 and a fixing tube 100. The battery 14 is disposed within the body 12. The fixing tube 100 is disposed between the body 12 and the battery 14, the fixing tube 100 includes a tube body 110. The tube body 110 has an accommodating space S and the tube body 110 is made of a breakable material. The battery 14 is suitable for being accommodated in the accommodating space S, and the tube body 110 is suitable for being adhered to the body 12, so as to fix the battery 14 in the body 12.

According to present embodiment, the fixing tube 100 fixes the battery 14 in the body 12 by using the tube body 110 composed by the breakable material. The breakable material is suitable for being torn manually, for example, by hands, or being destroyed by operating a hand tool manually, for example, with a scissor. When the battery 14 is to be detached from the body 12 for maintenance of the electronic apparatus 10, the fixing tube 100 is capable of preventing the battery 14 from deformation or damages caused by external forces, so as to maintain overall shape integrity of the battery 14 during the detaching process.

The body 12 may be, for example, composed by a circuit board and a body shell of the electronic apparatus 10. The battery 14 may be adhered on the body 12 by, for example, adhering the fixing tube 100 to the circuit board or a shielding case of the circuit board. In addition, the battery 14 may also be adhered to a support chassis within the body shell. However, structures of the body 12 and methods for adhering the battery 14 to the body 12 are not particularly limited in the disclosure. In order to easily tear the tube body 110 of the fixing tube 100, the tube body 110 may further includes a convex ear 112, and the convex ear 112 is protruded from an edge of the tube body 110.

Structure characteristics of the fixing tube 100 according to the present embodiment are further described as follows. Continually referring to FIGS. 1A, 1B, and 1C together. According to the present embodiment, the tube body 110 of the fixing tube 100 further includes an accommodating entrance E, and the battery 14 is suitable for entering the accommodating space S through the accommodating entrance E. The fixing tube 100 further includes a first adhesive layer 120, which is disposed on the tube body 110, and the tube body 110 is suitable for being adhered to the body 12 through the first adhesive layer 120 (as illustrated in FIG. 2). In addition, the fixing tube 100 further includes a second adhesive layer 130, which is disposed on the tube body 110, and the tube body 110 is suitable for being adhered to the battery 14 through the second adhesive layer 130, and orthographic projections of the first adhesive layer 120 and the second adhesive layer 130 on the tube body 110 are not overlapping one another. In other words, when the battery 14 is attached to the fixing tube 100, an adhesive region between the battery 14 and the fixing tube 100 and an adhesive region between the fixing tube 100 and the body 12 are not overlapping one another. Therefore, when the tube body 110 is destroyed, a portion of the tube body 110 where the second adhesive layer 13 is disposed for fixing the battery 14 may be removed from the body 12, so as to avoid difficulties in detachment caused by one specific portion in the tube body 110 being adhered to the battery 14 and the body 12 at the same.

According to present embodiment, a first tube body surface 110a is provided outside of the tube body 110 of the fixing tube 100, and the first adhesive layer 120 is disposed on the first tube body surface 110a, so as to fix the fixing tube 100 on the body 12 (as illustrated in FIG. 2). A second tube body surface 110b is disposed inside of the tube body 110 of the fixing tube 100, and the second adhesive layer 130 is disposed on the second tube body surface 110b (i.e., a region depicted with dotted lines as illustrated in both FIG. 1A and FIG. 1C), so as to fix the battery 14 in the accommodating space S.

According to the present embodiment, the tube body 110 of the fixing tube 100 further includes a first sidewall 114, a second sidewall 116 opposite to the first sidewall 114, a bottom plate 117 facing the accommodating entrance E, and a first connecting sidewall 111 and a second connecting sidewall 115 respectively connected to the first sidewall 114 and the second sidewall 116. The accommodating space S is composed by said sidewalls 111, 114, 115, 116 and the bottom plate 117, so that the tube body 110 of the present embodiment may have a shape similar to a cubic and an opening of said cubic as the accommodating entrance E. However, shapes of the tube body 110 are not particularly limited in the disclosure. Moreover, the tube body 110 further includes a bonding portion 118 located at the accommodating entrance E, the bonding portion 118 is extended from one of the first sidewall 114 and the second sidewall 116. The accommodating entrance E is closed by the bonding portion 118 when the bonding portion 118 is adhered to another one of the first sidewall 114 and the second sidewall 116. More specifically, in FIG. 1A, the bonding portion 118 is extended from a side of the second sidewall 116 adjacent to the accommodating entrance E. The bonding portion 118 includes a covering region 118a connected to the second sidewall 116 and an adhesive region 118b connected to the covering region 118a. Therefore, when the bonding portion 118 is bended along a common boundary between the bonding portion 118 and the second sidewall 116, accommodating entrance E may be covered by the covering region 118a of the bonding portion 118, and the adhesive region 118b of the bonding portion 118 may be adhered to the first sidewall 114.

According to the present embodiment, the covering region 118a may cover a part of the accommodating portion E, so as to avoid the covering region 118a and an external circuit 14a of the battery 14 from interfering each other. A common boundary between the bonding portion 118 and the second sidewall 116 and a common boundary between the coverage 118a and the adhesive region 118b may also be a bending line. However, the common boundary is not limited only to be the bending line and the forms of the common boundaries is not particularly limited in the disclosure.

According to the present embodiment, the bonding portion 118 further includes a third adhesive layer 118c, the third adhesive layer 118c is disposed on the adhesive region 118b, and the bonding portion 118 is adhered to the first sidewall 114 through the third adhesive layer 118c.

According to the present embodiment, the first sidewall 114 has a first sidewall opening 114a, and the second sidewall 116 has a second sidewall opening 116a. After the battery 14 of the electronic apparatus 10 of FIG. 2 is used for a long period of time, an expansion may automatically occurred on the batter 14, the first sidewall opening 114a and the second sidewall opening 116a provides a cushion space between the tube body 110 and the body 12 (as illustrated in FIG. 2), so as to cushioning the expansion of the battery.

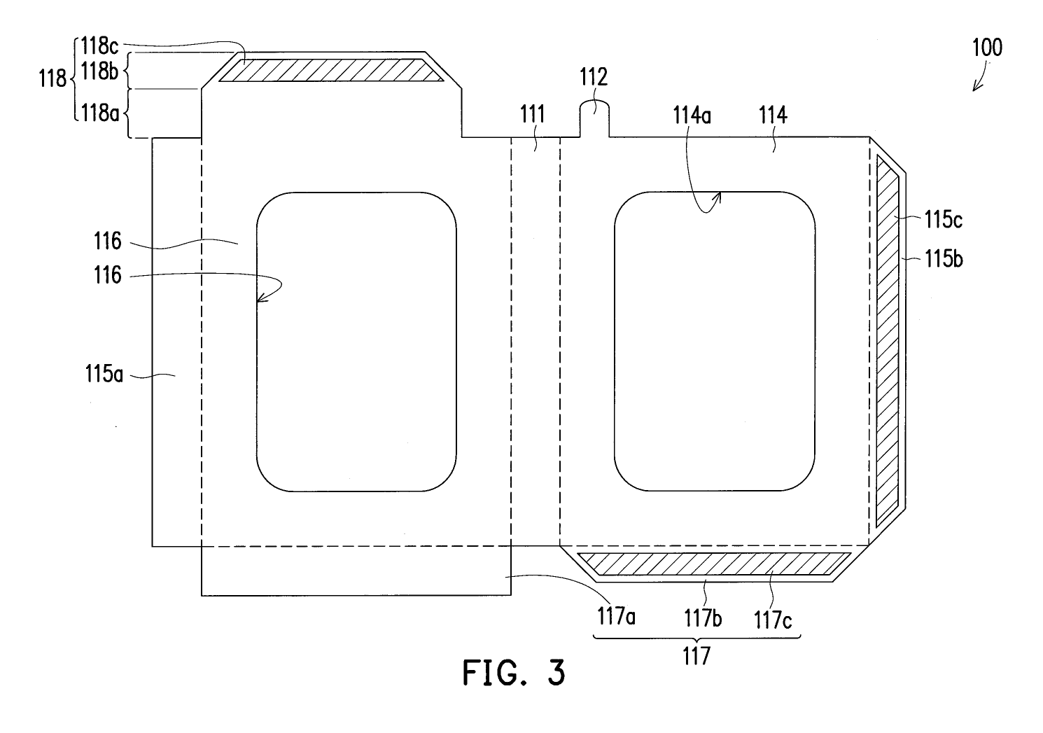

FIG. 3 is a top view illustrating the fixing tube of FIG. 1A being unfold. Referring to FIG. 3, the tube body 110 of the present embodiment may be made of, for example, a sheet material being cropped and bended, the sheet material may be, for example, mylar, paper and thin metal film. However, the disclosure is not limited thereto. A first connecting sidewall 111 is provided between the first sidewall 114 and the second sidewall 116, and sides of the first sidewall 114 and the second sidewall 116 being far away from the first connecting sidewall 111 are respectively provided with sidewall connecting portions 115a and 115b. One of the sidewall connecting portions 115a and 115b has an adhesive layer 115c, which is capable of bonding and fixing the sidewall connecting portions 115a and 115b to one another when the sheet material is bended to form the tube body 100, so as to compose a second connecting sidewall 115 of the tube body 110 (as shown in FIG. 1B). In addition, bottom connecting portions 117a and 117b are respectively provided to the first sidewall 114 and the second sidewall 116 on their sides closed to the bottom portion. One of the bottom connecting portions 117a and 117b has an adhesive layer 117c, which is capable of bonding one another when the sheet material is bended to form the tube body 100, so as to compose a second connecting sidewall 117 of the tube body 110. However, the tube body 110 of the fixing tube 100 is not limited only to be the sheet material being bended, and the structures of the sheet material is also not particularly limited in the disclosure.

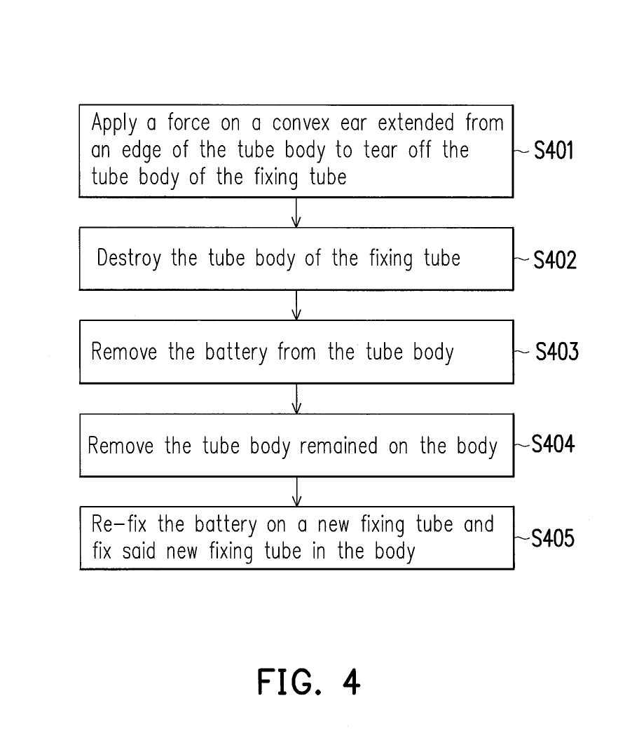

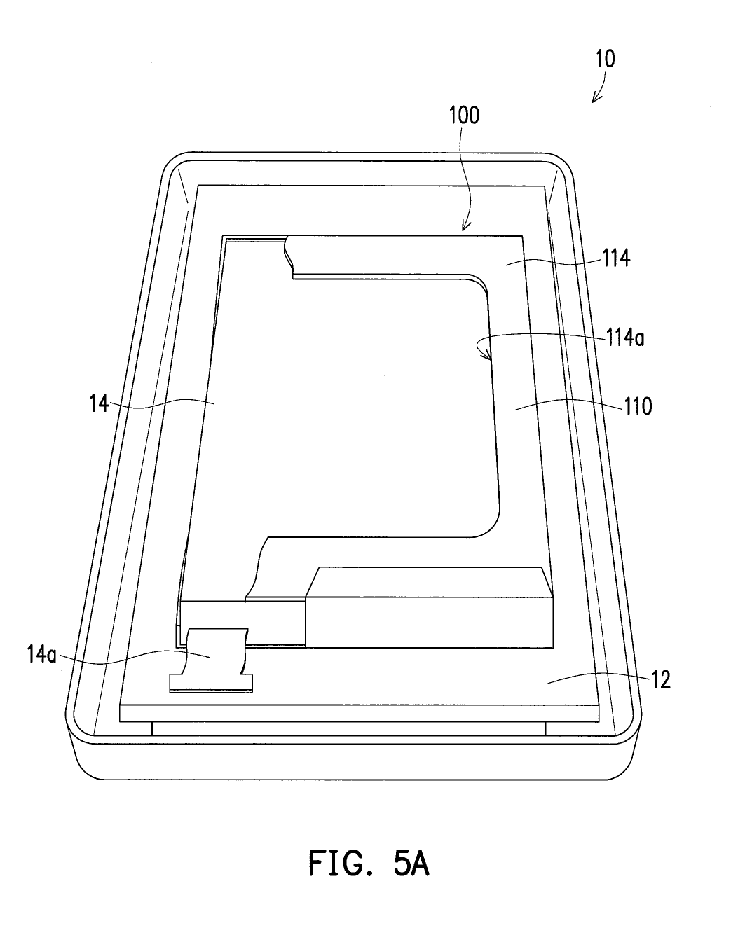

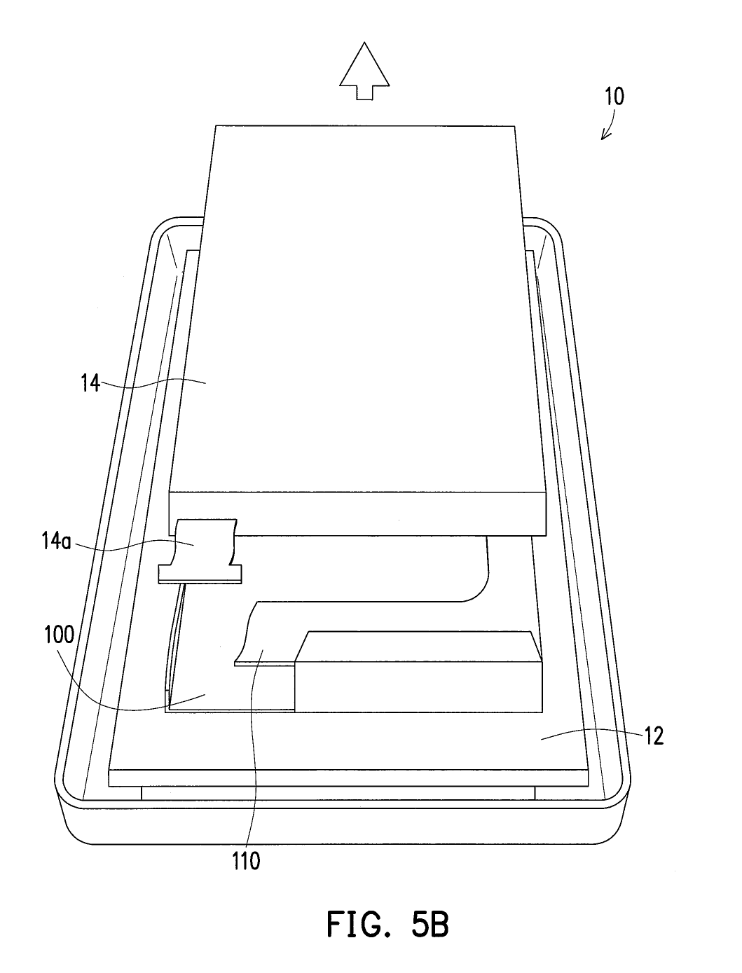

FIG. 4 is a flowchart illustrating a method for detaching and attaching the battery of the electronic apparatus of FIG. 2. FIGS. 5A and 5B are schematic views respectively illustrating the electronic apparatus of FIG. 2 before the battery is detached and after the battery is detached. Referring to FIGS. 4, 5A and 5B together, after the body shell outside of the battery 14 is detached from the body 12 for maintenance of the electronic apparatus 10 using the fixing tube 100 of the present embodiment, the electronic apparatus 10 is in a state as shown in FIG. 2. Next, in step S402, the tube body 110 of the fixing tube 100 is destroyed as shown in FIG. 5A, so that the battery 14 cannot be fixed to a position with respect to the body 12 due to destruction of the tube body 110, and the battery 14 may be removed from the body 12 accordingly. More specifically, according to the present embodiment, a step S401 is further provided before the step of destroying the tube body 110 (i.e., S402), in which a force is applied to the convex ear 112 protruded from an edge of the tube body 110, so that the tube body 110 of the fixing tube 100 may be destroyed by pulling up the convex ear 112. After the tube body 110 is destroyed, in step S403, the battery 14 and the tube body 110 are unattached as shown in FIG. 5A, so that the battery 14 may be detached from the body 12.

Referring to FIG. 5B, when the battery 14 and the body 12 are separated from each other, a portion of the tube body 110 of the fixing tube 100 and the first adhesive layer 120 (as illustrated in FIG. 1B) may still be remained on the body 12. After maintenance of the electronic apparatus 10 is completed, step S404 may be performed to remove the portion of the tube body 110 and the first adhesive layer 120 (as illustrated in FIG. 1B) remained on the body 12. Next, in step S405, the battery 14 is re-fixing to another fixing tube 100, so that the fixing tube 100 and the battery 14 may be re-fixed in the body 12.

Based on above, the disclosure may fix a battery to a body by disposing a fixing tube between the battery and the body. The fixing tube has an accommodating space for accommodating the battery, and a tube body of the fixing tube is composed by a breakable material. Once the battery is to be removed from the electronic apparatus, only the fixing tube is required to be torn, so that the tube body may be destroyed to fix the battery in the body correspondingly, such that battery may be removed from the body. A convex ear disposed on an edge of the tube body is capable of allowing the tube body to be easily torn when removing the battery. In addition, sidewall openings are also provided on the sidewalls of the tube body so as to cushioning the expansion of the battery after being used for a long period of time. As a result, during the process of detaching the battery from the electronic apparatus, the disclosure may reduce overall maintaining costs of the electronic apparatus by preventing the battery being deformed by external forces.

Although the disclosure has been described with reference to the above embodiments, it is apparent to one of the ordinary skill in the art that modifications to the described embodiments may be made without departing from the spirit of the disclosure. Accordingly, the scope of the disclosure will be defined by the attached claims not by the above detailed descriptions.

What is claimed is:

1. A fixing tube suitable for accommodating a battery and fixing the battery in a body of an electronic apparatus, the fixing tube comprises:
a tube body having an accommodating space, the tube body is made of a breakable material, wherein the battery is suitable for being accommodated in the accommodating space, and the tube body is suitable for being adhered to the body, thereby fixing the battery in the body.

2. The fixing tube of claim 1, wherein the tube body further comprises an accommodating entrance, and the battery is suitable for entering the accommodating space through the accommodating entrance.

3. The fixing tube of claim 1, further comprising:
a first adhesive layer disposed on the tube body, wherein the tube body is adapted to be adhered to the body through the first adhesive layer.

4. The fixing tube of claim 3, further comprising:
a second adhesive layer disposed on the tube body, wherein the tube body is adapted to be adhered to the battery through the second adhesive layer, and orthographic projections of the first adhesive layer and the second adhesive layer on the tube body are not overlapping one another.

5. The fixing tube of claim 1, wherein the tube body further comprises:
a first sidewall;
a second sidewall disposed opposite to the first sidewall;
a first connecting sidewall connected to the first sidewall and the second sidewall;
a second connecting sidewall connected to the first sidewall and the second sidewall, the second connecting sidewall faces the first connecting sidewall; and
a bottom plate connected to the first sidewall, the second sidewall, the first connecting sidewall and the second connecting sidewall.

6. The fixing tube of claim 5, wherein the tube body further comprises:
a bonding portion extended from one of the first sidewall and the second sidewall, wherein the accommodating entrance is closed by the bonding portion when the bonding portion is adhered to another one of the first sidewall and the second sidewall.

7. The fixing tube of claim 6, wherein the bonding portion has a third adhesive layer, and the bonding portion is adhered to the another one of the first sidewall and the second sidewall through the third adhesive layer.

8. The fixing tube of claim 7, wherein the first sidewall has a first sidewall opening, and the second sidewall has a second sidewall opening.

9. The fixing tube of claim 1, where the breakable material is suitable for being torn manually or being destroyed by operating a hand tool manually.

10. The fixing tube of claim 9, wherein the tube body is a sheet material, and the sheet material comprises mylar, paper and thin metal film.

11. The fixing tube of claim 1, wherein the tube body further comprises a convex ear, and the convex ear is protruded from an edge of the tube body.

12. An electronic apparatus, comprising:
a body;
a battery disposed within the body; and
a fixing tube disposed between the body and the battery, the fixing tube comprises:
a tube body having an accommodating space, the tube body is made of a breakable material, wherein the battery is suitable for being accommodated in the accommodating space, and the tube body is suitable for being adhered to the body, thereby fixing the battery in the body.

13. The electronic apparatus of claim 12, wherein the tube body further comprises an accommodating entrance, and the battery is suitable for entering the accommodating space through the accommodating entrance.

14. The electronic apparatus of claim 12, further comprising:
a first adhesive layer disposed on the tube body, wherein the tube body is adapted to be adhered to the body through the first adhesive layer.

15. The electronic apparatus of claim 14, further comprising:
a second adhesive layer disposed on the tube body, wherein the tube body is adapted to be adhered to the battery through the second adhesive layer, and orthographic projections of the first adhesive layer and the second adhesive layer on the tube body are not overlapping one another.

16. The electronic apparatus of claim 15, wherein the fixing tube comprises:
a first sidewall;
a second sidewall disposed opposite to the first side; a first connecting sidewall connected to the first sidewall and the second sidewall;
a second connecting sidewall connected to the first sidewall and the second sidewall, the second connecting sidewall faces the first connecting sidewall; and
a bottom plate connected to the first sidewall, the second sidewall, the first connecting sidewall and the second connecting sidewall.

17. The electronic apparatus of claim 16, wherein the fixing tube comprises:
a bonding portion extended from one of the first sidewall and the second sidewall, wherein the accommodating entrance is closed by the bonding portion when the bonding portion is adhered to another one of the first sidewall and the second sidewall.

18. The electronic apparatus of claim 17, wherein the bonding portion has a third adhesive layer, and the bonding portion is adhered to the another one of the first sidewall and the second sidewall through the third adhesive layer.

19. The electronic apparatus of claim 18, wherein the first sidewall has a first sidewall opening, and the second sidewall has a second sidewall opening.

20. The electronic apparatus of claim 12, where the breakable material is suitable for being torn manually or being destroyed by operating a hand tool manually.

21. The electronic apparatus of claim 20, wherein the tube body is a sheet material, and the sheet material comprises mylar, paper and thin metal film.

22. The electronic apparatus of claim 12, wherein the tube body further comprises a convex ear, and the convex ear is protruded from an edge of the tube body.

23. A method for detaching and attaching a battery, suitable for detaching the battery from a body of an electronic apparatus, a fixing tube comprising a tube body having an accommodating space, the tube body being made of a breakable material, wherein the battery is suitable for being accommodated in the accommodating space, and the tube body is suitable for being adhered to the body, thereby fixing the battery in the body, the method for detaching the battery comprises:
destroying the tube body of the fixing tube so the tube body cannot fix the battery; and
detaching the battery from the body.

24. The method for detaching and attaching the battery of claim 23, wherein the step of destroying the tube body of the fixing tube further comprises:
applying a force to a convex ear protruded from an edge of the tube body for tearing the tube body of the fixing tube.

25. The method for detaching and attaching the battery of claim 23, wherein the step of attaching the battery further comprises:
removing the tube body remained on the body after detaching the battery from the body.

26. The method for detaching and attaching the battery of claim 23, wherein the step of attaching the battery further comprises:
re-attaching the battery to another fixing tube after removing the tube body remained on the body, and fixing the fixing tube and the battery in the body.
